(19) United States
(12) Patent Application Publication
(10) Pub. No.: US 2010/0026458 A1
(43) Pub. Date: Feb. 4, 2010

(54) Expansion module for portable gaming devices and system for providing localized environmental interaction

(75) Inventors: Amber Samdahl, Sierra Madre, CA (US); Jonathan Ackley, Glendale, CA (US); Joshua B. Gorin, Los Angeles, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/220,968

(22) Filed: Jul. 29, 2008

(51) Int. Cl. H04Q 5/22

(52) U.S. Cl. 340/10.1

(57) ABSTRACT

There is provided a Radio Frequency Identification (RFID) expansion module for portable gaming devices. The RFID expansion module comprises an interface connector that can receive power and exchange data with a portable gaming device, an RFID tag that can exchange data with and power its antenna using the portable gaming device, a storage device, and a program data containing software code enabling communication between the portable gaming device and the RFID tag, including the enabling and disabling of a power link to the RFID tag. There is also provided a system for providing localized environmental interaction using the RFID expansion module. The system comprises a plurality of RFID readers detecting RFID tags in defined localized environments, a portable device connected to the RFID expansion module, a control module for coordinating the overall system, an environmental module to trigger events, and a network for communication between system modules.

### BACKGROUND OF THE INVENTION

1. Field of the Invention

The present invention relates generally to electronic circuits and systems. More particularly, the present invention relates to communications systems for transmission of digital data.

2. Background Art

Once the exclusive domain of a few enthusiasts, computer devotees and programmers, video games now rival movies and other traditional entertainment media in terms of sales and mainstream adoption by the public. During the formative earlier years of gaming, video game developers were often preoccupied with adding complexity and challenge, satisfying core gamers but failing to appeal to casual users. Recently, a trend towards making video games more widely accessible has significantly broadened the potential audience of video game players.

In many cases, video games have been rendered more accessible through the introduction of new paradigms for interaction besides the traditional game controller, which can intimidate first time gamers with its ever evolving and intimidating mass of buttons and joysticks. Interfaces that are more intuitive to use, such as motion sensing controllers, touch sensitive screens, and interactive musical instruments have made video games easier to pick up and play. As a result, casual gamers unwilling to undertake onerous time commitments can bypass the traditional rites of memorizing complex button sequences and reading lengthy instruction manuals.

Besides making interfaces more intuitive, modern video games have also broadened the social aspect of gaming beyond the traditional solitary experience in front of the television. Advances in wireless technology and network infrastructure have enabled video gamers to challenge or cooperate with fellow gamers across the room or around the world. The constant shrinking of electronic processes has also enabled portable gaming to become ubiquitous today, further allowing video games to permeate the social sphere. An office worker commuting on the train might play the daily Sudoku puzzle downloaded onto his mobile phone; a college student might accomplish a few quick online quests with his friends between classes on his portable gaming system; a seasoned chess veteran might instead play an extended online chess match with his associate from Russia. Portable networked games are providing new and exciting game experiences for everyone to enjoy.

Yet, there still remains much new ground to be explored, particularly in the field of interactive location dependent gaming. Overwhelmingly, modern networked games have disregarded the physical location of the game player. The only exception might be during registration, since licensing agreements and other considerations may render it prudent to restrict membership to a particular territory or country. However, the actual game portion typically does not leverage the current physical location of the user to affect game play. Only technical details transparent to the user, such as the routing of network packets, rely on the physical location of the user.

One reason why interactive location dependent gaming has not seen widespread adoption is the inability to precisely locate a user using current methods. Estimating location based on the user's network address only provides a very rough estimate of the user's location, typically only at the city level. If the user is connected to the network by a mesh of wireless hotspots, the user's position might be triangulated using the particular hotspot the user is connected to, but again this estimation only provides a rough guide. If the user's gaming device has GPS capabilities, the location estimation will provide much more detail, but current limitations in GPS technology typically restrict positional accuracy to a few meters, which may be still too inaccurate for meaningful feedback in the context of an interactive portable game.

Accordingly, there is a need to overcome the drawbacks and deficiencies in the art by providing a way to locate a user of a portable networked game with needed accuracy and to provide that location to the network.

### SUMMARY OF THE INVENTION

An expansion module for portable gaming devices and system for providing localized interaction, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1a presents a block diagram of an RFID expansion module for portable gaming devices, in accordance with one embodiment of the present invention;

FIG. 1b presents a block diagram of one exemplary RFID expansion module for portable gaming devices, including an embedded RFID tag;

FIG. 1c presents a block diagram of another exemplary RFID expansion module for portable gaming devices, including an embedded RFID reader;

FIG. 1d presents a block diagram of another exemplary RFID expansion module for portable gaming devices, including an embedded RFID tag and an RFID reader;

FIG. 2 presents a localized environmental interaction system for use with the RFID expansion module of FIG. 1a, in accordance with one embodiment of the present invention; and

FIG. 3 presents another localized environmental interaction system for use with the RFID expansion module of FIG. 1a, in accordance with another embodiment of the present invention.

### DETAILED DESCRIPTION OF THE INVENTION

The present application is directed to an RFID expansion module for portable gaming devices and a system for providing localized environmental interaction using the RFID expansion module. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

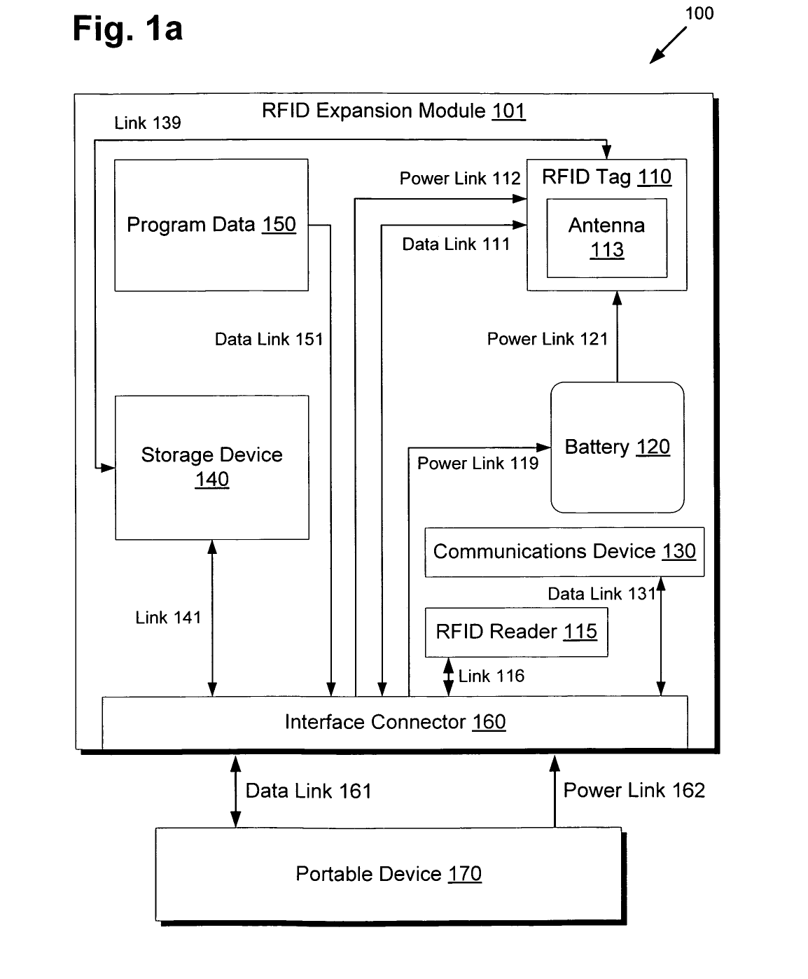

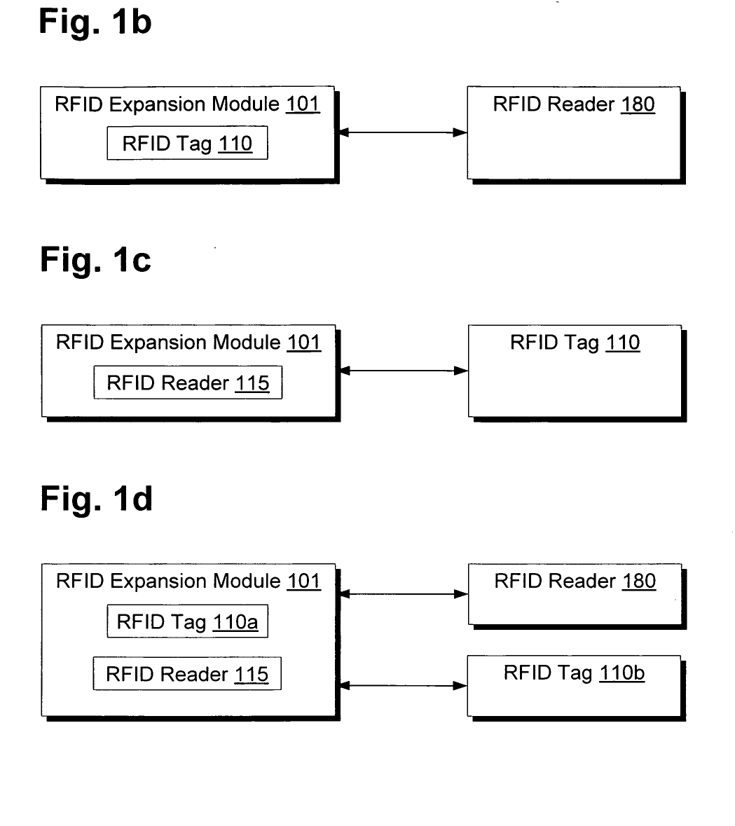

FIG. 1a presents a diagram of an RFID expansion module, in accordance with one embodiment of the present invention. RFID expansion module environment 100 includes RFID expansion module 101 and portable device 170. Through interface connector 160, RFID expansion module 101 can receive power and exchange data with portable device 170 using power link 162 and data link 161, respectively. RFID expansion module 101 includes RFID tag 110, RFID reader 115, battery 120, communications device 130, storage device 140, program data 150, and interface connector 160. RFID tag 110 provides the interface for RFID data exchange with storage device 140 and interface connector 160 using link 139 and data link 111, respectively. RFID tag 110 also includes antenna 113 to implement the RFID data exchange. RFID tag 110 can be an active tag that receives power from interface connector 160 and battery 120 using power links 112 and 121, respectively. RFID reader 115 can exchange data with interface connector 160 using link 116. Battery 120 can receive power from interface connector 160 using power link 119. Communications device 130 can exchange data with interface connector 160 using data link 131. Storage device 140 can exchange data with interface connector 160 using link 141. Program data 150 can provide data to interface connector 160 using data link 151.

It should be emphasized that FIG. 1a is only one particular implementation of the RFID expansion module. For instance, battery 120 could be removed, leaving RFID tag 110 to retrieve power directly from interface connector 160 only. Communications device 130 and RFID reader 115 could be removed, sacrificing some secondary communications functionality. Similarly, other components such as program data 150 and storage device 140 might instead be located in a separate module or on portable device 170. Program data 150 might also be embedded within storage device 140. Stripped down to the basics, RFID expansion module 101 might only include some implementation of an RFID interface and interface connector 160.

Several embodiments of different RFID interfaces are illustrated in FIGS. 1b, 1c, and 1d, presenting various RFID tag and reader configurations. In FIG. 1b, RFID tag 110 communicates with environmental RFID readers such as RFID reader 180. Alternatively, as in FIG. 1c, RFID reader 115 might substitute for RFID tag 110, with RFID tags such as RFID tag 110 placed in the surrounding environment instead, effectively swapping the placement of the RFID readers and RFID tags. If robust RFID capabilities are needed, both RFID reader 115 and an RFID tag 110a may be embedded in RFID expansion module 101 as shown in FIG. 1d, thus allowing communication with both RFID readers and RFID tags placed in the surrounding environment, such as RFID reader 180 and RFID tag 110b.

Portable device 170 may represent any number of devices, but the embodiment for the purposes of discussion shall be a handheld gaming device with a battery and network access via wireless. A typical game cartridge for use by portable device 170 might include program data 150, storage device 140, and interface connector 160. Program data 150 could include game program code and data assets, such as graphics, sound, and scenario data. Generally, program data 150 would be a read only memory as shown by unidirectional data link 151, but there may be situations where program data 150 could be rewriteable, such as a generic storage cartridge for storing downloaded games rather than a preloaded game. If program data 150 is rewriteable, it might be included in storage device 140. Storage device 140 could also contain non-volatile user data, such as save game data and other personal settings. In RFID expansion module 101, storage device 140 might also be shared with RFID tag 110 as additional storage directly accessible through link 139, or indirectly accessible through link 141. Interface connector 160 may provide the physical interface to portable device 170, implemented by an exposed row of electrical contacts held in place by friction or some other connecting means.

In the present embodiment, RFID expansion module 101 may represent a game cartridge for use with the handheld gaming device, enhanced with additional hardware providing communications and RFID functionality. RFID tag 110 provides the core RFID functionality, broadcasting RF data using antenna 113. Through data link 111, RFID tag 110 can communicate with portable device 170, receiving data to relay to an RFID reader, or sending data received from the RFID reader. If logistical or other reasons preclude network connectivity for the RFID readers, the RFID tag can function as a storage space to provide updated data states in addition to the usual identification function. Thus, RFID readers placed in the environment can receive updated data state from the RFID tag as an alternative to a network, allowing game progress to be tracked independently of a network. Additionally, RFID tag 110 might also use storage device 140 as an intermediary space for exchanging and storing data, as RFID tag 110 may have limited storage space for data state information.

As an example of using RFID tags to provide updated data states, consider that a player must solve a puzzle before a door opens. Once portable device 170 detects that the player has successfully solved the puzzle, it may represent this accomplishment by a flag implemented by a data bit. This data bit might be included in a stream of bits representing the state of the player within the game, which would be provided to RFID tag 110 for storage. An RFID reader placed near the door could then read the stream of bits from RFID tag 110, confirm that the player solved the puzzle as indicated by a binary 1 status of the data bit, and proceed to activate the door to open for the player. Thus, the environment is able to react to the player based on the game state, without the traditional requirement of a network to propagate the updated game state information.

In order to transmit data, RFID tag 110 requires antenna 113, which might implement a passive tag, an active tag, a semi-passive tag, a semi-active tag, or some hybrid combination. The tags are differentiated principally by the method of supplying power to the antenna. Passive tags have no power source, relying on the energy from the incoming signal itself. As a result, passive tags have a low distance of operation. Active tags have access to a power source, allowing higher antenna transmission power and thus extending the distance of operation. Semi-passive tags also have a power source, but only use the power for tag circuitry, which can boost sensitivity. Semi-active tags, on the other hand, can direct the power source to amplify the signal. The power source is usually an embedded battery, which requires additional space and will eventually run out of battery charge.

In the present embodiment, RFID tag 110 can power antenna 113 using power link 112, which receives power from portable device 170. Such embodiment provides additional control over battery drain from the RFID, since the cartridge software can control the beacon rate of the active RFID tag, i.e. the number of times per minute the active RFID tag transmits its RF signal). Because an embedded RFID tag battery is not necessary, the externally powered RFID tag enjoys a smaller size advantage over traditional active RFID tags. This consideration may be especially important if cartridges for portable device 170 conform to a standardized form factor that leaves little extra room for additional circuitry. This is often the case with modern portable gaming devices, as the cartridges are typically specified to be only large enough to hold program data chips and a small amount of user storage.

Additionally, portable device 170 might be configured to turn on power link 112 only when RFID functionality is required, preventing unnecessary power draw from the limited power supply of portable device 170. This power limiting functionality might be extended to allow precise control over distance detection from environmental RFID readers. By varying the power level provided to antenna 113, the distance required before RFID tag 110 can successfully communicate with an RFID reader can be changed. This power control might be implemented by providing circuitry to control variable power levels to antenna 113, or by using multiple RFID tags configured with various antenna strengths and thus detectable distances. Messages received over network or program data 150 executing on portable device 170 might direct RFID tag 110 to use a particular power level or to use a particular RFID tag to variably control detection distances for different applications.

For example, recalling the puzzle and door situation discussed above, RFID tag 110 might be configured to detect within a few feet of the RFID reader near the door. Other distances may be less appropriate, since detection within a few inches requires the player to almost run into the door to trigger it, and detection within an extended distance may cause the door to trigger even though it is across a corridor. Similarly, other situations may merit a different optimum detection range, which can be configured by varying the power provided to RFID tag 110 for antenna 113. For example, there might be a special effect trigger where a mechanical sea monster rises from the middle of a lake. This requires a long distance detection range so that players do not have to wade into the lake to witness the sea monster rising. Thus, RFID tag 110 could be instructed to supply additional power to antenna 113, or an alternative RFID tag with longer broadcast distance might be used instead of RFID tag 110.

RFID expansion module 101 can be configured to use a wide variety of RFID interface configurations. FIG. 1a features a robust configuration corresponding to FIG. 1d, including both an RFID tag and an RFID reader. Although this configuration is the most flexible, it also requires the most resources and hardware. Alternatively, only an RFID reader might be included; users are equipped with RFID readers, and the environment is embedded with RFID tags, as in FIG. 1c. RFID expansion module 101 includes only RFID reader 115, adding support for detecting RFID tags that are placed in the environment. This may be desirable if no network is available, as program data 150 could be preprogrammed to understand a set of RFID tags and respond accordingly. However, RFID readers need to detect RFID tags within a broad spatial range, rather than simply responding to a received RF signal as a RFID tag does, translating to larger antenna and power requirements. Space constraints might thus render this implementation less desirable, since RFID reader 115 might require a large amount of space and power for the antenna and circuitry. Thus, an alternative implementation might only include RFID tag 110 as in FIG. 1b.

Similarly, at the cost of extra space and power, communications device 130 might provide a secondary communications channel, such as an infrared receiver and transmitter for communication between RFID expansion modules. Battery 120 can provide rechargeable backup power to RFID tag 110, enabling RFID operation even when RFID expansion module 101 is disconnected from portable device 170 or power link 162 is rendered unavailable. Components may be selectively included or omitted to achieve a desired configuration balancing functionality with space and power limitations.

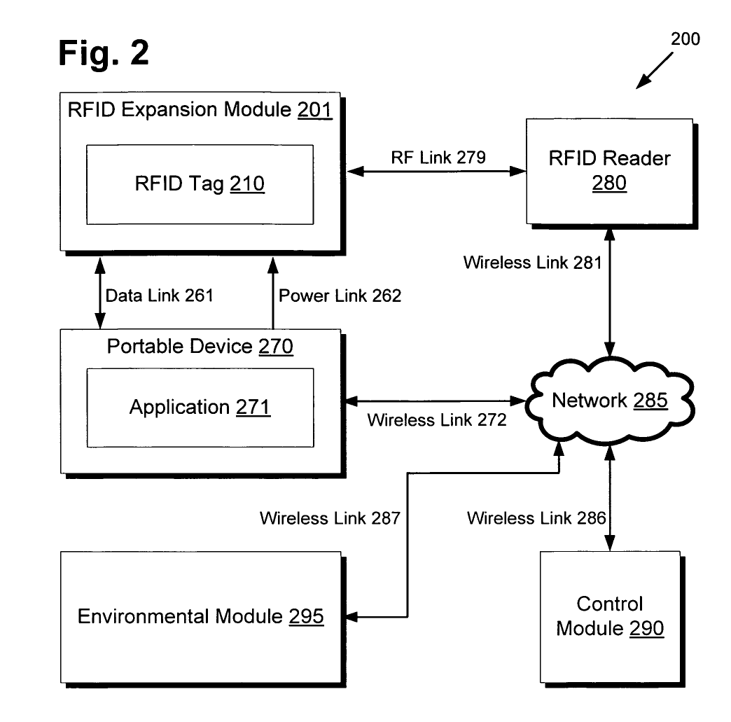

Now that the RFID expansion module has been introduced, FIG. 2 presents a localized environmental interaction system for use with the RFID expansion module, in accordance with one embodiment of the present invention. Localized environmental interaction system 200 includes RFID expansion module 201, portable device 270, RFID reader 280, network 285, control module 290, and environmental module 295. RFID expansion module 201 including RFID tag 210 corresponds to RFID expansion module 101 and RFID tag 110 in FIG. 1a. Portable device 270 corresponds to portable device 170 in FIG. 1a, and further contains application 271. Data link 261 corresponds to data link 161 in FIG. 1a, and power link 262 corresponds to power link 162 in FIG. 1a. RFID expansion module 201 can exchange data with portable device 270 and RFID reader 280 using data link 261 and RF link 279, respectively, and can receive power from portable device 270 using power link 262. Network 285 can exchange data with portable device 270, RFID reader 280, control module 290, and environmental module 295 over wireless links 272, 281, 286 and 287, respectively.

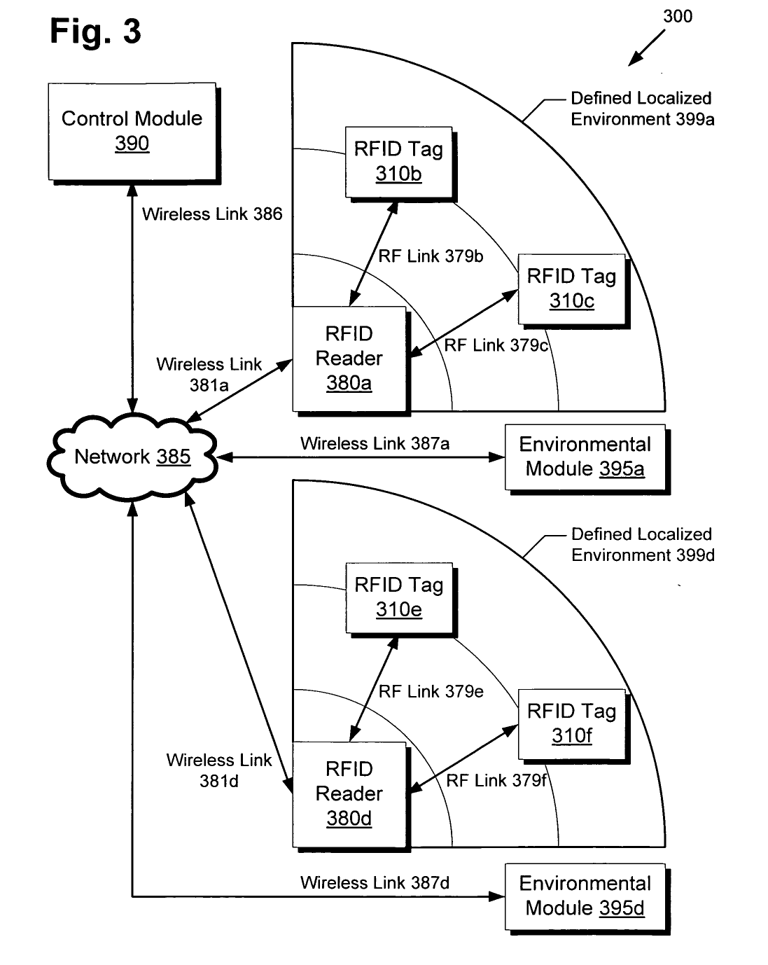

To introduce the discussion of localized environmental interaction system 200, only one RFID reader and one RFID tag are presented, communicating in a single defined localized environment. A system with multiple RFID readers, multiple RFID tags, and multiple defined localized environments will be discussed below in conjunction with FIG. 3.

A user equipped with RFID expansion module 201 attached to portable device 270 might be exploring a controlled environment such as a theme park. Having some degree of control over the environment is beneficial, because the positions of the RFID readers should be well defined for the system to work optimally. One such defined position might be RFID reader 280, which is configured to detect and communicate with RFID tags within a predefined range. For the present example, consider the range to be a conical shape extending 1 meter, and also consider that RFID tag 210 is within that conical shape. RFID reader 280 might be hidden in an object like an animated figure, reacting to RFID tags detected within the conical shape extending in front of it through the use of environmental module 295. Environmental module 295 might comprise a network accessible device that coordinates figure animation and outputs sound, also hidden within the figure.

However, environmental module 295 does not necessarily have to be located near RFID reader 280, or activate only an animated figure. Another embodiment might involve a maze game, where if RFID reader 280 detects RFID tag 210 in a certain room, remotely positioned environmental module 295 opens a door in a room located across a maze corridor. Environmental module 295 in communication with RFID reader 280 can also be configured to activate a wide variety of effects, such as initiating a special effects display, turning on a water fountain, or otherwise triggering a dynamic set element. For example, a pathway with multiple water fountains may have multiple environmental modules causing the nearest water fountain to sprout water into the air as a player with an RFID tag passes through. A display screen with an environmental module might beckon a nearby player by name, reading the name from the RFID tag. A spotlight might shine on the player when an environmental module detects the player has achieved some goal. These and many other effects can be triggered when environmental module 295 reads RFID tag 210 through RFID reader 280.

Continuing with the theme park example, the user may be playing an interactive game on portable device 270, represented by application 271. Since in FIG. 1a, RFID expansion module 101 is depicted as including program data 150, code for application 271 might be considered retrieved from RFID expansion module 201 in the present example. However, the program for application 271 could also be retrieved from another cartridge or module, or downloaded through a wireless connection, for example. Regardless of its origin, application 271 might query and communicate with RFID tag 210 using data link 261. For example, application 271 might request the ID number associated with the RFID tag, send and receive data with RFID reader 280, or even tell the RFID tag to change its ID number, should that functionality be desired for privacy or other reasons.

As previously mentioned, application 271 might also programmatically control the power link 262 to RFID tag 210 as well, conserving battery usage, selectively providing power for special events, or controlling antenna strength to limit detection range. Some examples were already given to limit the RFID detection range by varying the supplied power to the antenna, having a RFID reader near a door detect within a few feet whereas an RFID reader in the center of a lake would detect within a much larger distance. Antenna power might also be selectively turned on and off to enable or disable events from triggering. For example, RFID tag 210 might be normally set to be dormant and inactive until portable device 270 receives an instruction through network 285 to provide power to RFID tag 210. Control module 290 might be configured to send a wireless signal to all portable devices at midnight during an electric light parade, instructing all RFID tags to be enabled, for example. Then, RFID readers placed throughout the theme park might react to RFID tags now detected around them, instructing a corresponding environmental module 295 to provide a customized light and laser show based on the users' video game characters, for example. In this manner, the controlled power ability provided by RFID expansion module 210 can enable dramatic interactivity with the environment.

Considering another example of environmental interactivity, RFID expansion module 201 might integrate a video game for use with the theme park, comprising a puzzle game where patrons of the theme park must gather clues scattered throughout the park and answer riddles on their portable gaming device. Midway through the progress of the game, the next clue might be obtained from the animated figure previously mentioned. However, the figure will not provide the clue unless the user has successfully solved the previous riddle, which might be indicated by a data flag.

The decision where to store and process the data flag might depend on the robustness and availability of network 285 to mediate such information. In the present example, network 285 might be considered reliable and capable of handling many users, so game logic decisions and user game state data might be centrally processed in control module 290, which might represent a network server located in the theme park data center. If network 285 were less reliable, some of this data storage and processing might be offloaded to other locations, such as RFID expansion module 201, RFID tag 210, or portable device 270. Additionally, environmental module 295 might be more closely integrated with RFID reader 280 if network availability is a concern, circumventing the need to route through network 285. The availability of particular wireless links from particular sources might also dictate the strategy for data storage and processing. For example, if portable device 270 can be assumed to have a reliable wireless link 272, then wireless link 281 might be removed to save on infrastructure costs. On the other hand, if portable device 270 lacks wireless link 272, then data might be routed through wireless link 281 instead.

Continuing the puzzle game example, at the time RFID tag 210 is detected by RFID reader 280 through RF link 279, RFID reader 280 might query control module 290 through wireless links 281 and 286 going through network 285 whether the user has successfully solved the previous puzzle and has the proper data flag. If the user did not solve the puzzle, the RFID reader might take no further action, leaving the animated figure motionless. However, if control module 290 indicates that the proper flag has been stored, the RFID reader might send an instruction to environmental module 295 through network 285, instructing it to begin animating the figure and announcing the clue for the user. To keep the different game states of users from interfering with each other, control module 290 might customize the clue and riddles for each player so that it is unlikely that the same riddle and clue will be provided within a certain time period. This can be easily accomplished because the unique ID number associated with RFID tag 210 uniquely identifies each player.

Thus, with the aid of RFID expansion module 201, localized environmental interaction system 200 is able to provide an interactive networked gaming experience, tightly integrating physical location into game play. Without the aid of RFID expansion module 201, the precise location of users can only be given a broad estimation at best. Leveraging the power supply available to portable device 270 and the low cost availability of RFID tags, RFID expansion module 201 can provide a cost effective and integrated solution for location dependent gaming without the need for excess bulk and batteries. By providing accurate tracking of RFID tagged guests, RFID expansion module 201 opens up exciting possibilities for location dependent gaming, where the puzzle game example represents only the tip of the iceberg.

Moving to FIG. 3, FIG. 3 presents another localized environmental interaction system for use with the RFID expansion module, in accordance with another embodiment of the present invention. FIG. 3 illustrates a system where multiple defined localized environments are utilized. Localized environmental interaction system 300 includes defined localized environments 399a and 399d, network 385, control module 390, and environmental modules 395a and 395d. Network 385, control module 390, environmental modules 395a and 395d, RFID tags 310b, 310c, 310e, 310f, and RFID readers 380a and 380d correspond to network 285, control module 290, environmental module 295, RFID tag 210, and RFID reader 280 from FIG. 2, respectively. Wireless links 386, 381a, 381d, 387a, and 387d correspond to wireless links 286, 281, 281, 287, and 287 from FIG. 2, respectively. RF links 379b, 379c, 379e, and 379f all correspond to RF link 279 from FIG. 2. Defined localized environment 399a includes RFID reader 380a and RFID tags 310b and 310c. RFID reader 380a can communicate with RFID tags 310b and 310c using RF links 379b and 379c respectively. Similarly, defined localized environment 399d includes RFID reader 380d and RFID tags 310e and 310f. RFID reader 380d can communicate with RFID tags 310e and 310f using RF links 379e and 379f respectively. Network 385 can communicate with control module 390, RFID readers 380a and 380d, and environmental modules 395a and 395d using wireless links 386, 381a and 381d, and 387a and 387d respectively.

Localized environmental interaction system 300, in FIG. 3, provides an example of how the RFID expansion module might be utilized in the context of a larger network, covering multiple discrete areas with multiple RFID readers. For the sake of simplicity, the combination of the RFID expansion module and the portable device from FIG. 2 is simplified to merely an RFID tag in FIG. 3 in order to emphasize the RF links to the RFID readers. Other than the addition of multiple RFID readers and RFID tags within different defined localized environments, FIG. 3 is similar in presentation to FIG. 2.

Continuing with the puzzle game example introduced previously, a riddle displayed on the portable gaming device might present players with a choice in a two-way branching pathway, the pathway selected representing what the player thinks the answer to the riddle might be. For example, the riddle might inquire about shape of the Earth, and players might be instructed to embark on path A if they believe the Earth is flat, or to embark on path D if they believe the Earth is round. To make things more interesting, there might be an obstacle course in both paths to offer a deeper challenge and an incentive not to backtrack.

As previously mentioned, as a result of the unique ID numbers the RFID tags provide for each player, the riddle might be customized for each individual player to keep game play varied among players. For example, the question might be different, or the answer pathways might be swapped around. However, for the sake of simplicity, all players in the present example might be given the same riddle and the same pathway instructions.

At the end of each pathway, there might be a RFID reader embedded into a bench, inviting players to sit down. For example, consider that RFID reader 380a represents the end of path A (Earth is flat), while RFID reader 380d represents the end of path D (Earth is round). When the players represented by RFID tags 310b and 310c sit on the bench, they will come within the area encompassed by defined localized environment 399a. RFID reader 380a will thus be able to communicate with RFID tags 310b and 310c using RF links 379b and 379c, respectively. Through network 285, RFID reader 380a might use control module 390 to check whether the players have chosen the correct pathway to their riddles. Since it was stipulated that all players might receive the same riddle and pathways, path A will be the incorrect pathway, so control module 390 might relay to environmental module 395a that the players associated with RFID tags 310b and 310c have chosen the wrong pathway. Environmental module 395a might be a network accessible television screen facing the RFID reader embedded bench. Environmental module 395a might display a message of encouragement to the players associated with RFID tags 310b and 310c, exhorting them to not give up and keep playing.

Consider that defined localized environment 399d might comprise a similar setup to defined localized environment 399a, with an RFID reader embedded into a bench and a network accessible television screen facing the bench. When RFID tags 310e and 310f are detected as the corresponding players sit on the bench, RFID reader 380d might consult control module 390 to check the answer status of RFID tags 310e and 310f. Control module 390 might then direct environmental module 395d to display congratulatory messages informing them they have won a virtual prize in the video game, and additionally send a return message back to RFID reader 380d, instructing the portable devices associated with RFID tag 310e and 310f to add the promised virtual prize to each player's video game inventory. Although not shown in FIG. 3, this return message might alternatively be sent directly to the portable devices associated with each RFID tag, if each portable device has a wireless connection to network 385.

As described in the foregoing, an RFID expansion module for portable gaming devices and a system for providing localized environmental interaction support interactive gaming where users can interact with the environment based on their physical location as detected by RFID technology. Since the RFID expansion module can rely on the power supply of a connected portable device, it can be designed to use cost effective and space saving RFID tags using external power for antenna amplification. Additionally, connectivity with the portable device as an attachable expansion module allows tighter integration with application code, providing richer user experiences. In conjunction with a broader network such as a wireless mesh network, compelling interactivity can be implemented in RFID controllable environments such as theme parks with specifically positioned RFID readers and supporting environmental modules.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A radio-frequency identification (RFID) expansion module for use by a portable gaming device, the RFID expansion module comprising:
an interface connector connectable to the portable gaming device, the interface connector including a power link to receive power and a data link to exchange data;
an RFID tag, the RFID tag including an antenna such that the RFID tag can supply the antenna with power received from the power link, the RFID tag further configured to exchange data using the data link; and
a storage device communicable with the RFID tag.

2. The RFID expansion module of claim 1 further comprising:
a program data compatible with the portable gaming device, the program data containing software code enabling communication between the portable gaming device and the RFID tag, the software code further configurable to programmatically enable and disable the power link to the RFID tag.

3. The RFID expansion module of claim 1, wherein the RFID tag is further configured to receive power from a battery configurable to recharge through the power link.

4. The RFID expansion module of claim 3, wherein the RFID tag uses the battery to continue operating when disconnected from the portable gaming device.

5. The RFID expansion module of claim 1, further including a communications device.

6. The RFID expansion module of claim 6, wherein the communications device comprises an infrared transmitter and receiver.

7. The RFID expansion module of claim 1, further including an RFID reader.

8. A game cartridge for use by a portable gaming device, the game cartridge comprising:
a program data compatible with the portable gaming device;
an interface connector connectable to the portable device, the interface connector including a power link to receive power from the portable device;
an radio-frequency identification (RFID) tag, the RFID tag including an antenna such that the RFID tag can supply the antenna with power received from the power link.

9. The game cartridge of claim 8, wherein the game cartridge includes a storage device communicable with the RFID tag.

10. The game cartridge of claim 8, wherein the RFID tag is further configured to exchange data using a data link on the interface connector.

11. The game cartridge of claim 8, wherein the program data contains software code enabling communication between the portable gaming device and the RFID tag.

12. The game cartridge of claim 11, wherein the software code can programmatically enable and disable the power link to the RFID tag.

13. The game cartridge of claim 8, wherein the RFID tag is further configured to receive power from a battery.

14. The game cartridge of claim 13, wherein the battery is rechargeable through the interface connector.

15. The game cartridge of claim 13, wherein the RFID tag can use the battery to continue operating when disconnected from the portable device.

16. The game cartridge of claim 8, further including a communications device.

17. The game cartridge of claim 16, wherein the communications device comprises an infrared transmitter and receiver.

18. The game cartridge of claim 8, further including an RFID reader.
